(19) United States
(12) Patent Application Publication
(10) Pub. No.: US 2021/0357530 A1
(43) Pub. Date: Nov. 18, 2021

(54) INFORMATION COMPUTING APPARATUS, INFORMATION COMPUTING METHOD, AND NON-TRANSITORY COMPUTER READABLE STORAGE MEDIUM

(71) Applicant: Yahoo Japan Corporation, Tokyo (JP)

(72) Inventors: Kota TSUBOUCHI, Tokyo (JP); Teruhiko TERAOKA, Tokyo (JP); Hidehito GOMI, Tokyo (JP); Junichi SATO, Tokyo (JP)

(21) Appl. No.: 17/197,267

(22) Filed: Mar. 10, 2021

(30) Foreign Application Priority Data
Mar. 19, 2020 (JP) 2020-050233

(51) Int. Cl. G06F 21/62; H04N 1/44; G06F 21/84

(52) U.S. Cl. CPC G06F 21/6245; G06F 21/84; H04N 1/4493

(57) ABSTRACT

An information processing apparatus according to the present application includes an acquisition unit that acquire content to be disclosed from a user's terminal apparatus and a specifying unit that specifies a portion of the acquired content that meets a predetermined condition set in advance.

### CROSS-REFERENCE TO RELATED APPLICATION(S)

The present application claims priority to and incorporates by reference the entire contents of Japanese Patent Application No. 2020-050233 filed in Japan on Mar. 19, 2020.

### BACKGROUND OF THE INVENTION

### 1. Field of the Invention

The present invention relates to an information processing apparatus, an information processing method, and a non-transitory computer readable storage medium.

### 2. Description of the Related Art

Conventionally, a technique related to concealment processing for protecting privacy of a subject is known (see JP 2019-71050 A).

The above technique cannot individually specify targets of the concealment processing within the same image and perform different processing contents with respect to each targets although a privacy level indicating a degree of image modification can be set. In addition, content such as documents and voice other than images is excluded from targets of the concealment processing.

### SUMMARY OF THE INVENTION

It is an object of the present invention to at least partially solve the problems in the conventional technology.

According to an aspect of an embodiment of the present application, an information processing apparatus includes an acquisition unit that acquires content to be disclosed from a user's terminal apparatus and a specifying unit that specifies a portion of the acquired content that meets a predetermined condition set in advance.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates an example of an information offering system according to an embodiment;

FIG. 2 illustrates an example of a configuration of a terminal apparatus according to the embodiment;

FIG. 3 illustrates an example of a configuration of an information offering apparatus according to the embodiment;

FIG. 4 illustrates an example of a policy information database according to the embodiment;

FIG. 5 is a flowchart illustrating an example of a flow of offering processing according to the embodiment; and

FIG. 6 illustrates an example of a hardware configuration.

### DETAILED DESCRIPTION OF THE PREFERRED EMBODIMENTS

A mode for carrying out an information processing apparatus, an information processing method, and a non-transitory computer readable storage medium according to the present application (hereinafter referred to as an “embodiment”) will be described in detail below with reference to the drawings. Note that the information processing apparatus, information processing method, and non-transitory computer readable storage medium according to the present application are not limited by this embodiment. Further, in the embodiments below, identical elements are given identical reference signs, and repeated description thereof is omitted.

### EMBODIMENT

### 1. Configuration of Information Offering System

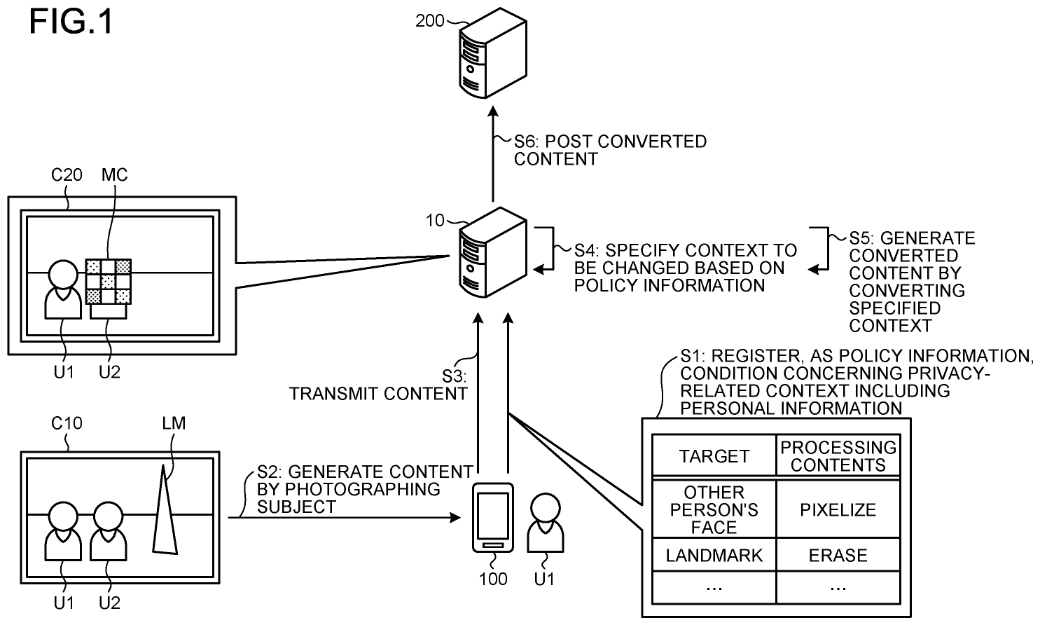

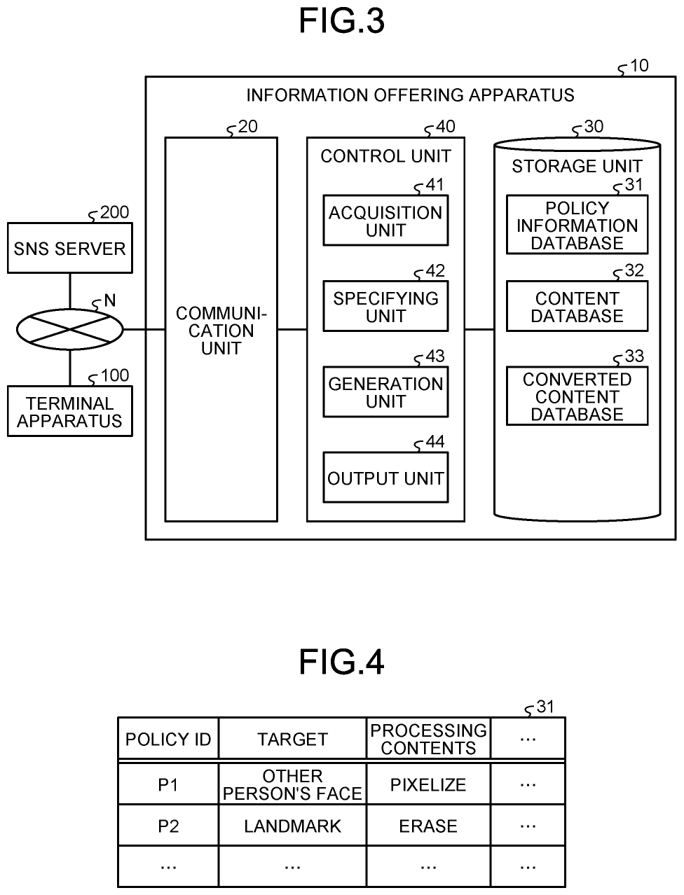

First, a configuration of an information offering system 1 having a terminal apparatus 100 or an information offering apparatus 10, which is an example of an information processing apparatus, is described with reference to FIG. 1. FIG. 1 illustrates an example of the information offering system 1 according to an embodiment. As illustrated in FIG. 1, the information offering system 1 includes the information offering apparatus 10, the terminal apparatus 100, and a Social Networking Service (SNS) server 200. Note that the information offering system 1 has a plurality of terminal apparatuses 100. Further, the information offering apparatus 10 and the SNS server 200 may be implemented in the same server apparatus, cloud system, or the like. The information offering apparatus 10, the terminal apparatus 100, and the SNS server 200 are communicably connected to each other over a network N (see, for example, FIG. 3) by wire or wirelessly.

The information offering apparatus 10 is an information processing apparatus that performs diminishing processing according to a privacy-related context including personal information on content to be disclosed (e.g., a photo, a document, a moving image, voice) and is, for example, implemented in a server apparatus, a cloud system, or the like. Specifically, the information offering apparatus 10 specifies a privacy-related context including personal information among contexts included in content acquired from the terminal apparatus 100, performs changing processing (diminishing processing) on the context, and posts the converted content (diminished content) obtained after the change to the SNS server 200. In the present embodiment, a condition concerning the privacy-related context including personal information is set in advance on the user's terminal apparatus 100. For example, the context may be information including a person to whom content may be disclosed (target person) or a person to whom content should not be disclosed (non-target person).

The terminal apparatus 100 is a smart device such as a smartphone or a tablet PC, and is a mobile terminal apparatus that can communicate with any server apparatus over a wireless communication network such as 3 Generation (3G) or Long Term Evolution (LTE). Further, the terminal apparatus 100 has a screen such as a liquid crystal display that has a touch panel function and accepts various kinds of user's operations such as tapping operation, sliding operation, and scrolling operation on displayed data such as content by a finger, a stylus, or the like. Note that, hereinafter, an operation performed on a region where content is displayed within the screen is sometimes referred to as an operation on the content. Note that the terminal apparatus 100 is not limited to a smart device and may be an information processing apparatus such as a desktop Personal Computer (PC) or a notebook PC.

The SNS server 200 is an information processing apparatus that offers an SNS service and is, for example, implemented in a server apparatus, a cloud system, or the like. For example, the SNS server 200 is an information processing apparatus that offers a communication function between users (members) having the terminal apparatuses 100 over a network, and may offer functions such as a profile function, a message transmission/reception function, a timeline function, a user mutual link function, a user search function, a blog function, a questionnaire function, and/or a community function.

### 2. Processing Performed by Information Offering System

In the information offering system 1, the information offering apparatus 10 and the terminal apparatus 100 perform the following offering processing. Although an example of processing in which proposed data is offered to a user by processing performed by the terminal apparatus 100 is described below, the offering processing described below may be partially or entirely implemented in the information offering apparatus 10.

For example, the information offering apparatus 10 specifies a context that satisfies a predetermined condition among contexts included in content acquired from the terminal apparatus 100, performs changing processing on the context, and posts the converted content obtained after the change to the SNS server 200.

when the information offering apparatus 10 specifies a context that satisfies a predetermined condition among contexts included in content acquired from the terminal apparatus 100, the information offering apparatus 10 determines whether or not the contexts included in the content meet the predetermined condition (policy). The predetermined condition is a condition concerning a privacy-related context including personal information.

In a case where the content acquired from the terminal apparatus 100 includes a photo (image) and a posted text (text), the information offering apparatus 10 performs an analysis, for example, by any of the following four patterns.

(1) Analyze only a photo

(2) Analyze both a photo and a posted text

(3) Do analysis by using multiple photos

(4) Do analysis by using a time element and a photo

For example, in a case where the condition concerning the context is “keep the address secret”, the information offering apparatus 10 determines that the context is related to the address when both of the following two conditions are met: 1) a title or a description of the posted text includes an expression such as “near my home” or “beautiful fireworks from the window of my home”, and 2) the fireworks are visible from this angle on the photo. In other words, although there is no problem if the content includes only a sentence “fireworks are beautiful” and a photo, the information offering apparatus 10 determines that the condition concerning the context is not met if the content includes a photo and a sentence suggesting that the photo was taken at the home such as “beautiful fireworks from my home”.

A user sets information which the user does not want to be known in the information offering apparatus 10 by using the terminal apparatus 100 in advance, and when the user attempts to make a post including such information, the information offering apparatus 10 blurs the information.

In this way, the information offering apparatus 10 grasps, as a context, a privacy-related matter including personal information and performs diminishing processing according to the context. For example, in a case where a user does not want a kid's face to be disclosed in an image or a moving image, the information offering apparatus 10 blurs a kid's face so that the kid's face cannot be recognized or puts some sort of mark on the face although a face of a person other than a kid is displayed as it is. Moreover, in a case where a user does not want a current location or a place of residence to be known, the information offering apparatus 10 pixelizes an image from which an address can be specified or converts the image into another image. In addition, in the case of text data, voice data, or the like, the information offering apparatus 10 erases a character string or voice from which an individual or an address can be specified or converts the character string or the voice into another character string or voice. Alternatively, the information offering apparatus 10 may hide the character string or voice by using symbols for hiding words or black painting or a self-regulation sound (covering sound).

Note that, the information offering apparatus 10 makes a confirmation inquiry to the user in advance if it is determined that the user's post has a problem concerning privacy protection. For example, the information offering apparatus 10 makes an inquiry such as “The content includes an address. Do you really want to post it?”.

Furthermore, the information offering apparatus 10 automatically shifts a posted time and then makes a post in a case where real-time posting has a risk of revealing of a current location and violation of privacy (for example, a post concerning a lunch). In this case, the information offering apparatus 10 specifies a post concerning a lunch or the like and makes the post after elapse of a preset time (for example, 3 hours later).

That is, in the present embodiment, not mere concealment processing using image modification, but diminishing processing for specifying and concealing a context to be changed comprehensively for the whole content is performed.

2-1. Example of Offering Processing

A specific example of the offering processing is described below with reference to FIG. 1. The following discusses content including image data as an example. The image data may be a still image or a moving image. Note that, in reality, content is not limited to image data and may include text data, voice data, and the like.

First, the user's terminal apparatus 100 registers, in the information offering apparatus 10, a condition concerning a privacy-related context including personal information in advance as policy information so that the information offering apparatus 10 performs diminishing processing on content (Step S1). Note that the policy information may be information individually set with respect to each user or may be information common to a plurality of users. Each user may manually customize policy information based on a policy information template or may select any policy information from a list of a plurality of pieces of policy information.

The user's terminal apparatus 100 generates content by photographing a subject (Step S2). Specifically, the user's terminal apparatus 100 photographs a subject and then generates content based on image data thus obtained. Note that the content is an SNS message, data posted to an SNS, or the like.

In the example illustrated in FIG. 1, the user's terminal apparatus 100 photographs a user U1, a user U2, and a landmark LM as subjects and then generates content C10 including image data thus obtained. That is, the content C10 includes the user U1, the user U2, and the landmark LM.

The user's terminal apparatus 100 transmits the generated content to the information offering apparatus 10 (Step S3). Note that the information offering apparatus 10 may regularly acquire content from the user's terminal apparatus 100.

The information offering apparatus 10 specifies a context to be changed among contexts included in the content transmitted from the user's terminal apparatus 100 based on the policy information registered by the user's terminal apparatus 100 (Step S4). Then, the information offering apparatus 10 generates converted content by changing the specified context (Step S5).

In the example illustrated in FIG. 1, the policy information registered by the user's terminal apparatus 100 has “other person's face” as a context to be changed and “pixelize” as processing contents. Furthermore, the policy information has a “landmark” as a context to be changed and “erase” as processing contents.

Therefore, in the example illustrated in FIG. 1, the information offering apparatus 10 pixelizes the face of the user U2 in the content C10 based on the above-mentioned policy information. Furthermore, the information offering apparatus 10 erases the landmark LM. Here the face of the user U1 is the face of the user himself or herself and is therefore excluded from targets of the policy information. Then, the information offering apparatus 10 generates converted content C20 based on the content C10 by pixelizing the face of the user U2 while keeping the face of the user U1 as it is and erasing the landmark LM.

The information offering apparatus 10 posts the generated converted content to the SNS server 200 (Step S6). As a result, the SNS server 200 can disclose the posted converted content according to disclosure settings. The terminal apparatuses 100 of a plurality of users can view the disclosed converted content.

As described above, the information offering apparatus 10 changes a context that satisfies a predetermined condition among contexts included in content. Therefore, the policy information includes a condition concerning a context. The condition concerning a context may be, for example, a condition concerning a context of various kinds such as a context concerning a photographed person or a context concerning a relationship with a user who photographed the person such as a face or a relationship with a user who makes a post (whether or not they are parent and child, whether or not they are friends, or whether or not they are strangers), a context concerning date and time of photographing, a context concerning a location, and a context concerning a user's condition such as whether or not the user was traveling, whether or not the user was taking a walk, or whether or not the user was on a date. If content to be disclosed includes a context that matches the policy information, the information offering apparatus 10 need just disclose the content after modifying the context. Universal policy information may be automatically generated and stored after a user manually changes a context.

Further, the condition concerning a privacy-related context including personal information may be a condition concerning a context concerning a viewer who views disclosed content. In such a case, the condition concerning a context concerning a viewer is set in advance in the SNS server 200 (or the information offering apparatus 10) from the terminal apparatus 100 of the viewer. Then, the SNS server 200 (or the information offering apparatus 10 that has received content from the SNS server 200) may perform changing processing. For example, the SNS server 200 may perform the processes in Steps S4 and S5 described above. That is, the converted content may be automatically generated at a time of viewing according to a context concerning the viewer.

Furthermore, the condition concerning a privacy-related context including personal information may be a condition concerning a context including a portrait right, a copyright, or the like. For example, the context may be a photograph of an entertainer, a celebrity, or the like, a painting, contents of a comic or a book, an article of a newspaper or a magazine or a part thereof, contents of a movie or music or a part thereof, a poem or a lyric or a part thereof, or a corporate logo.

There are various types of policy information, such as policy information registered by a person who posts content, policy information registered by a content viewer, and policy information registered by a service provider (including policy information common to all users). The information offering apparatus 10 or the SNS server 200 may perform changing processing by selecting any of these pieces of policy information or combining any pieces of policy information.

The information offering apparatus 10 or the SNS server 200 may automatically generate policy information by analyzing user's content information or posted information and present or propose the generated policy information to the user, and then the user himself or herself may register the policy information.

Note that, although “other person's face” and “landmark” are given as examples of a context to be changed in the policy information in FIG. 1, the context may be a “character”, a “signboard”, a “poster”, or the like. That is, any object or part that is included in content and can be specified as a context to be changed can be registered as a context to be changed in the policy information.

Although “pixelize” and “erase” are given as examples of processing contents in the policy information in FIG. 1, “image change” (replacement with another image), “confirmation” (inquiry to a user), “metadata erasure”, “obscuring”, “anonymization”, “tokenization”, and the like can be registered. That is, any processing that can be performed on content can be registered as processing contents in the policy information.

In the example of FIG. 1, the appearance of the user U1 included in the converted content C20 can be changed to an avatar by setting policy information having “user himself or herself” as a context to be changed and changing to an “avatar” as processing contents. If the user has not disclosed his or her personal information (or does not want his or her personal information to be identified), such changing processing is also necessary.

The processing for specifying a context to be changed in policy information among contexts included in content can be implemented in using a model of various kinds. For example, the information offering apparatus 10 may collect content by crowdsourcing, input the collected content to a model and train the model to learn, as correct data, features of a context to be changed in policy information among contexts included in the collected content.

Alternatively, a model specialized for an individual may be created and trained. For example, policy information that is statistically frequently used may be generated from log data of a large number of users who use an SNS service.

In this case, the information offering apparatus 10 may input various image data into a model and train the model to learn, as correct data, image data of a subject to be changed in policy information. For example, in the example of FIG. 1, the information offering apparatus 10 may train a model to learn, as correct data, image data of other persons' faces and landmarks. As a result, if content includes another person's face or a landmark, it can be determined that the other person's face or the landmark is a context to be changed.

On the contrary, the information offering apparatus 10 may input various image data into a model and train the model to learn, as correct data, image data of a subject that is not a target to be changed in policy information. For example, in the example of FIG. 1, the information offering apparatus 10 may train a model to learn image data of the face of the user himself or herself as correct data. As a result, if content includes the face of the user himself or herself, it can be determined that this face is a context that is not changed.

The information offering apparatus 10 may input content into a model and train the model to learn converted content as correct data.

Note that arbitrary type of model can be adopted as the model. For example, the information offering apparatus 10 may adopt a Support Vector Machine (SVM) or a Deep Neural Network (DNN) as the model. In this case, the DNN may be a Convolutional Neural Network (CNN) or a Recurrent Neural Network (RNN). The RNN may be a Long short-term memory (LSTM) or the like. That is, arbitrary form of model can be adopted as the model. The model may be a model implemented in combining a plurality of models, for example, a model combining a CNN and an RNN.

The learning is, for example, deep learning using a deep neural network (DNN). Data mining or any of other machine learning algorithms may also be used. The information offering apparatus 10 trains the model by any of the various learning methods described above.

As described above, in the present embodiment, the information offering apparatus 10 acquires information on a real world (reality) detected by various sensors as sensing information and constructs a sensed world (sensed reality) from the acquired sensing information. Then, the information offering apparatus 10 offers a diminished world (diminished reality) obtained by erasing, changing, or decreasing ease of recognition of a target that meets a predetermined condition among various targets (corresponding to targets in the real world) included in the sensed world to a user (e.g., a viewer of an SNS) by various means. As a result, the information offering apparatus 10 can exclude information which the user does not want to recognize or information that does not want to be recognized by the user from targets to be recognized by the user.

In the present embodiment, the information offering apparatus 10 acquires content from the terminal apparatus 100, generates converted content based on the content, and posts the converted content to the SNS server 200. Accordingly, the information offering apparatus 10 also functions as an apparatus that performs a “preliminary check” when the terminal apparatus 100 posts content to an SNS. By thus posting content to the SNS server 200 via the information offering apparatus 10, safety regarding privacy protection is significantly improved as compared with a case where the terminal apparatus 100 posts content directly to the SNS server 200.

### 3. Configuration of Terminal Apparatus

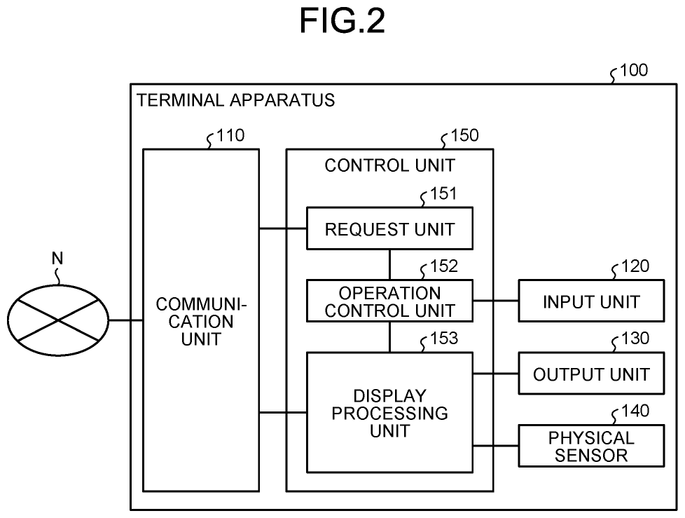

Next, a configuration of the terminal apparatus 100 according to the embodiment is described with reference to FIG. 2. FIG. 2 illustrates an example of a configuration of the terminal apparatus 100 according to the embodiment. As illustrated in FIG. 2, the terminal apparatus 100 includes a communication unit 110, an input unit 120, an output unit 130, a physical sensor 140, and a control unit 150.

The communication unit 110 is, for example, implemented in a Network Interface Card (NIC) or the like. Then, the communication unit 110 is connected to the network N by wire or wirelessly and transmits and receives information to and from the information offering apparatus 10.

The input unit 120 is an input device that receives various operations from a user. For example, the input unit 120 is implemented in a keyboard, a mouse, operation keys, or the like. The output unit 130 is a display device for displaying various kinds of information, that is, a screen. For example, the output unit 130 is implemented in a liquid crystal display or the like. Note that, when a touch panel is adopted for the terminal apparatus 100, the input unit 120 and the output unit 130 are integrated. In addition, in the following description, the output unit 130 is sometimes referred to as a screen.

The physical sensor 140 is a sensor that detects various kinds of physical information of the terminal apparatus 100, and is, for example, a gyro sensor, an acceleration sensor, an atmospheric pressure sensor, a temperature sensor, a sound volume sensor, a brightness sensor, or the like. Note that the physical sensor 140 may be a sensor that estimates a current position of the terminal apparatus 100 by using a positioning system such as a Global Positioning System (GPS). The terminal apparatus 100 can measure the position of the terminal apparatus 100 by using a technology such as Pedestrian Dead-Reckoning (PDR) using the acceleration sensor, the gyro sensor, the atmospheric pressure sensor, and the like. This makes it possible to acquire indoor position information, which is difficult to acquire by a positioning system such as GPS.

The physical sensor 140 also includes an image sensor. The image sensor is, for example, a Charge-Coupled Device (CCD) image sensor, a Complementary Metal Oxide Semiconductor (CMOS) image sensor, or the like. That is, the physical sensor 140 also serves as a camera function of the terminal apparatus 100.

The control unit 150 is implemented, for example, in executing various programs stored in a storage device inside the information offering apparatus 10 by a Central Processing Unit (CPU), a Micro Processing Unit (MPU), or the like while using a Random Access Memory (RAM) as a work area. For example, these various programs are application programs called web browsers. Alternatively, the control unit 150 is implemented, for example, in an integrated circuit such as an Application Specific Integrated Circuit (ASIC) or a Field Programmable Gate Array (FPGA).

As illustrated in FIG. 2, the control unit 150 includes a request unit 151, an operation control unit 152, and a display processing unit 153 and realizes or executes an information processing function or operation described below. Note that the internal configuration of the control unit 150 is not limited to the configuration illustrated in FIG. 2, and may be another internal configuration as long as information processing that will be described later is performed. Further, a connection relationship among the processing units included in the control unit 150 is not limited to the connection relationship illustrated in FIG. 2, and may be another connection relationship.

When the request unit 151 receives input data concerning policy information from the operation control unit 152, the request unit 151 transmits a request for registration of the policy information including the received input data to the information offering apparatus 10.

Furthermore, when the request unit 151 receives content from the operation control unit 152, the request unit 151 transmits a request for posting the content to the SNS server 200 to the information offering apparatus 10. In this case, the request unit 151 may transmit a content changing processing request according to the policy information to the information offering apparatus 10. Alternatively, when the request unit 151 receives content from the operation control unit 152, the request unit 151 transmits, to the information offering apparatus 10, a content changing processing request according to the policy information and a request to post converted content to the SNS server 200.

The operation control unit 152 executes various controls in accordance with a user's operation received via the input unit 120. For example, when the user performs various selection operations on the input unit 120, the operation control unit 152 outputs contents of the selection operations to the display processing unit 153. Further, the operation control unit 152 outputs contents of a user's operation such as a scrolling operation or a tapping operation received via the input unit 120 to the display processing unit 153.

The display processing unit 153 displays various received data on the output unit 130. For example, the display processing unit 153 performs processing for displaying data concerning policy information and content. The display processing unit 153 is, for example, implemented in execution by a CPU, an MPU, or the like while using a RAM as a work area.

### 4. Configuration of Information Offering Apparatus

Next, an example of a functional configuration of the information offering apparatus 10 according to the embodiment is described with reference to FIG. 3. FIG. 3 illustrates an example of a configuration of the information offering apparatus 10 according to the embodiment. As illustrated in FIG. 3, the information offering apparatus 10 includes a communication unit 20, a storage unit 30, and a control unit 40.

The communication unit 20 is, for example, implemented in a Network Interface Card (NIC) or the like. Then, the communication unit 20 is connected to the network N by wire or wirelessly and transmits and receives information to and from the terminal apparatus 100 and the SNS server 200.

The storage unit 30 is, for example, implemented in a semiconductor memory element such as a Random Access Memory (RAM), a flash memory, or the like, or a storage device such as a hard disk, an optical disk, or the like. Further, the storage unit 30 has a policy information database 31, a content database 32, and a converted content database 33.

Policy Information Database 31

The policy information database 31 stores therein policy information registered by the terminal apparatus 100. FIG. 4 illustrates an example of the policy information database according to the embodiment. In the example illustrated in FIG. 4, the policy information database 31 has items such as “policy ID (Identifier)”, “target”, and “processing contents”.

The “policy ID” indicates identification information for identifying policy information. Furthermore, the “target” indicates a context to be changed among contexts included in content. Note that the context to be changed is not limited to a subject or a part thereof included in image data, and may be a character string or a part thereof included in text data, a phrase or a part thereof included in voice data, or the like. Furthermore, the “processing contents” indicates contents of changing processing performed on a context to be changed.

For example, in the example illustrated in FIG. 4, policy information identified by a policy ID “P1” has “other person's face” as a context to be changed and “pixelize” as processing contents. Further, policy information identified by a policy ID “P2” has “landmark” as a context to be changed and “erase” as processing contents.

In this case, although abstract values such as “P1” and “P2” are used in the example illustrated in FIG. 4, it is assumed that information such as a specific character string or a numerical value is stored in “P1” and “P2”.

Note that the policy information database 31 is not limited to the one described above, and may store various information depending on the purpose. For example, the policy information database 31 may store therein identification information for identifying a user to which policy information is applied. Further, the policy information database 31 may store therein information indicating a type of content to which policy information is applied. In addition, the policy information database 31 may also store therein information about a context. For example, the policy information database 31 may store therein information indicating a user for whom content can be disclosed as it is (a content disclosing target person) and a user for whom converted content can be disclosed instead of content (a converted content disclosing target person).

Content Database 32

The content database 32 stores therein content acquired from the terminal apparatus 100. The content is an SNS message, data posted to an SNS, or the like. The content includes, for example, data related to a photo, a document, a moving image, voice, or the like. Further, the content is not limited to image data, text data, and voice data, and may include metadata or the like concerning such data.

Converted Content Database 33

The converted content database 33 stores therein converted content obtained after content acquired from the terminal apparatus 100 is subjected to changing processing according to policy information.

The control unit 40 is, for example, implemented in executing various programs stored in a storage device inside the information offering apparatus 10 by a Central Processing Unit (CPU), a Micro Processing Unit (MPU), or the like while using a RAM as a work area. Alternatively, the control unit 40 is, for example, implemented in an integrated circuit such as an Application Specific Integrated Circuit (ASIC) or a Field Programmable Gate Array (FPGA). As illustrated in FIG. 3, the control unit 40 includes an acquisition unit 41, a specifying unit 42, a generation unit 43, and an output unit 44.

The acquisition unit 41 acquires policy information from the terminal apparatus 100. That is, the acquisition unit 14 functions as a receiving unit that accepts a request for registration of policy information from the terminal apparatus 100. Further, the acquisition unit 14 acquires content from the terminal apparatus 100. In addition, the acquisition unit 14 may acquire a content conversion request, a posting request, or the like from the terminal apparatus 100.

The specifying unit 42 specifies a context to be changed among contexts included in content acquired by the acquisition unit 14 based on policy information acquired by the acquisition unit 14. Note that the specifying unit 42 may automatically specify a context to be changed when content is acquired or may specify a context to be changed in response to a request from the terminal apparatus 100 (e.g., a content conversion request, a posting request). That is, the specifying unit 42 may specify a context to be changed unconditionally for all pieces of content or may specify a context to be changed only upon receipt of a request.

Note that it should be noted that the above specifying processing can be implemented in any of various models. For example, the specifying unit 42 may collect images by crowdsourcing and train a model to learn features corresponding to each policy information among features included in the collected images. A model may be trained for each policy that can be set such as address or gender or a single model may be trained.

Further, the specifying unit 42 may set a target corresponding to policy information on a rule basis and determine whether or not the set target has been photographed. Such a determination can be implemented in a known model that specifies various photographed targets.

Alternatively, a model that has been appropriately trained may be used according to contents of policy information or a type of content to be disclosed or a method other than these methods may be used.

The generation unit 43 generates converted content by changing a context specified by the specifying unit 42 based on policy information acquired by the acquisition unit 14. That is, the generation unit 43 generates converted content by converting a context to be changed among contexts included in content based on policy information. Note that the generation unit 43 may automatically generate converted content when content is acquired or generate converted content in response to a request from the terminal apparatus 100 (e.g., a content conversion request, a posting request). That is, the generation unit 43 may generate converted content unconditionally for all pieces of content or may generate converted content only upon receipt of a request.

The output unit 44 outputs converted content generated by the generation unit 43 to the SNS server 200. That is, the output unit 44 posts the converted content to the SNS server 200.

### 5. Processing Flow of Terminal Apparatus 100

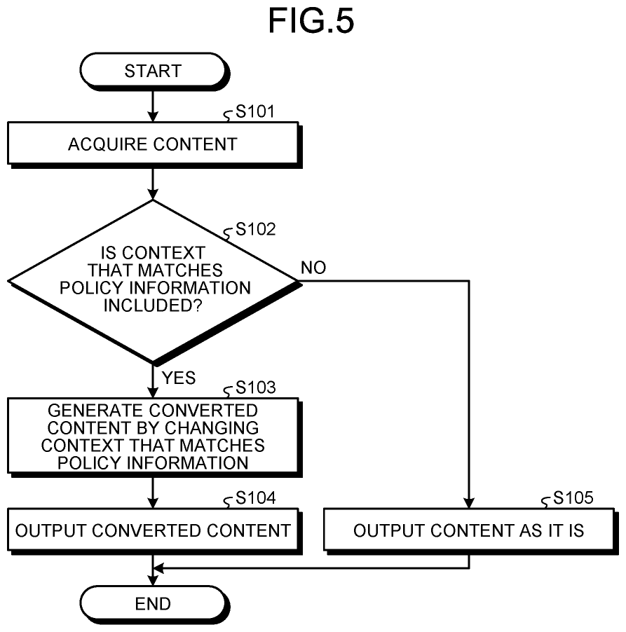

Next, a procedure of display processing performed by the terminal apparatus 100 and the information offering apparatus 10 that have executed control information is described with reference to FIG. 5. FIG. 5 is a flowchart illustrating an example of a flow of offering processing according to the embodiment.

For example, the information offering apparatus 10 acquires content from the user's terminal apparatus 100 (Step S101).

Then, the information offering apparatus 10 determines whether the acquired content includes a context that matches policy information (Step S102). That is, in a case where the acquired content includes a context that matches the policy information, the information offering apparatus 10 specifies the context that matches the policy information.

Then, in a case where the information offering apparatus 10 determines that the content includes a context that matches the policy information (Step S102; Yes), the information offering apparatus 10 generates converted content by changing the context (Step S103).

Then, the information offering apparatus 10 outputs the generated converted content to the SNS server 200 (Step S104). That is, the information offering apparatus 10 posts the generated converted content to the SNS server 200.

In this step, the information offering apparatus 10 may post the acquired content as it is to the SNS server 200 as content for a content disclosing target person from whom content need not be concealed. Further, the information offering apparatus 10 may post converted content to the SNS server 200 as content for a non-target person from whom at least a portion of content needs to be concealed, namely a converted content disclosing target person. That is, the information offering apparatus 10 may post two types of content, namely content for the target person and converted content for the non-target person to the SNS server 200.

In a case where the information offering apparatus 10 determines that the content does not include a context that matches the policy information (step S102; No), the information offering apparatus 10 outputs the acquired content as it is to the SNS server 200 since there is no context to be changed (step S105). That is, the information offering apparatus 10 posts the acquired content to the SNS server 200 as it is.

### 6. Modifications

An example of the offering processing has been described above. However, the embodiment is not limited to this. Modifications of the offering processing are described below. Note that the offering processing described below may be implemented in a function exerted by the terminal apparatus 100 side or may be implemented in a function exerted by the information offering apparatus 10 side.

6-1. Apparatus Configuration

Although an example in which the information offering system 1 includes the SNS server 200 has been described in the above embodiment, the embodiment is not limited to this. For example, the information offering apparatus 10 may have a function of returning converted content to the terminal apparatus 100 after receiving content from the terminal apparatus 100 and converting the content into the converted content. In such a case, the information offering apparatus 10 does not need to post the converted content to the SNS server 200. According to such a configuration, the information offering system 1 need not include the SNS server 200.

Furthermore, although an example in which the information offering system 1 includes the terminal apparatus 100 has been described in the above embodiment, the embodiment is not limited to this. For example, the information offering apparatus 10 may have a function of posting converted content to the SNS server 200 after acquiring content from the SNS server 200 and converting the content into the converted content. In such a case, the information offering apparatus 10 does not need to acquire content from the terminal apparatus 100. According to such a configuration, the information offering system 1 need not include the terminal apparatus 100.

Furthermore, although an SNS message, data posted to an SNS, and the like are given as examples of content in the above embodiment, the data may be, in fact, any data that is uploaded and disclosed on a network that is not limited to an SNS. For example, the content may be a HyperText Markup Language (HTML) document or the like disclosed as a web page.

Note that the information offering apparatus 10 may be implemented as a function of the user's terminal apparatus 100. Similarly, the information offering apparatus 10 may be implemented as a function of the SNS server 200.

6-2. Other Remarks

Moreover, among the processes described in the above embodiment, all or a part of the processes described as being automatically performed can be manually performed, or all or a part of the processes described as being manually performed can be performed automatically by a known method. The processing procedure, specific names, and information including various data and parameters illustrated in the above description and drawings can be changed in any ways unless otherwise specified. For example, the various kinds of information illustrated in the drawings are not limited to the illustrated information.

Further, each constituent element of each apparatus illustrated in the drawings is a functional concept and need not necessarily be configured as illustrated in the drawings physically. That is, the specific form of distribution/integration of each apparatus is not limited to the one illustrated in the drawings, and all or part thereof may be functionally or physically distributed/integrated in any unit according to various loads and usage conditions.

The above embodiments can be appropriately combined as long as processing contents do not contradict each other.

6-3. Program

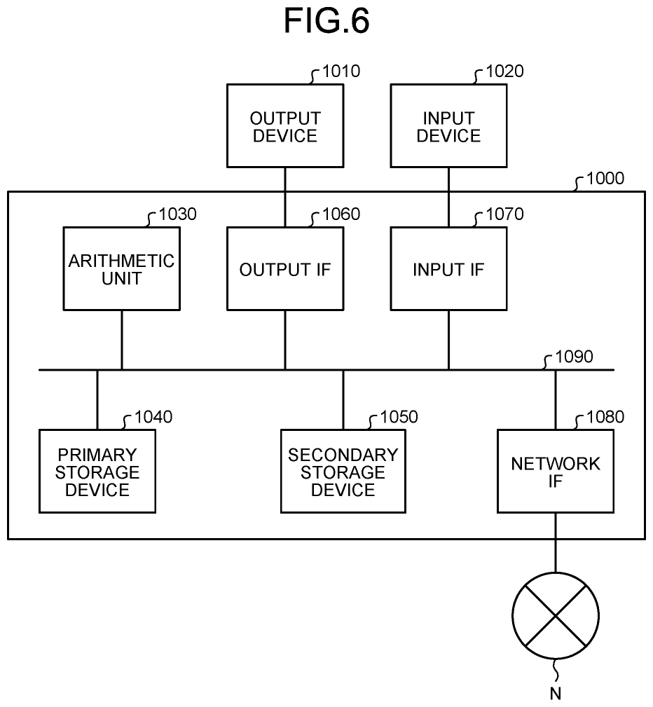

Further, the information offering apparatus 10 and the terminal apparatus 100 according to the above embodiment are, for example, implemented in a computer 1000 configured as illustrated in FIG. 6. FIG. 6 illustrates an example of the hardware configuration. The computer 1000 is connected to an output device 1010 and an input device 1020 and is configured such that an arithmetic unit 1030, a primary storage device 1040, a secondary storage device 1050, an output interface (IF) 1060, an input IF 1070, and a network IF 1080 are connected by a bus 1090.

The arithmetic unit 1030 operates, for example, based on a program stored in the primary storage device 1040 or the secondary storage device 1050 or a program read from the input device 1020 and executes various kinds of processing. The primary storage device 1040 is a memory device (e.g., a RAM) that temporarily stores therein data used for various kinds of computation by the arithmetic unit 1030. Further, the secondary storage device 1050 is a storage device in which data used for various kinds of computation by the arithmetic unit 1030 and various databases are registered and is implemented in a Read Only Memory (ROM), an HDD, a flash memory, or the like.

The output IF 1060 is an interface for transmitting information to be output to the output device 1010 (e.g., a monitor, a printer) that outputs various kinds of information and is, for example, implemented in a connector of standard such as a Universal Serial Bus (USB), a Digital Visual Interface (DVI), or a High Definition Multimedia Interface (HDMI) (registered trademark). In addition, the input IF 1070 is an interface for receiving information from the input device 1020 of various kinds such as a mouse, a keyboard, or a scanner and is, for example, implemented in a USB or the like.

Note that the input device 1020 may be, for example, a device that reads out information from an optical recording medium such as a Compact Disc (CD), a Digital Versatile Disc (DVD), or a Phase change rewritable Disk (PD), a magneto-optical recording medium such as a Magneto-Optical disk (MO), a tape medium, a magnetic recording medium, a semiconductor memory, or the like. The input device 1020 may be an external storage medium such as a USB memory.

The network IF 1080 receives data from another device over the network N and transmits the received data to the arithmetic unit 1030 and transmits data generated by the arithmetic unit 1030 to another device over the network N.

The arithmetic unit 1030 controls the output device 1010 and the input device 1020 via the output IF 1060 and the input IF 1070. For example, the arithmetic unit 1030 loads a program from the input device 1020 or the secondary storage device 1050 onto the primary storage device 1040 and executes the loaded program.

For example, in a case where the computer 1000 functions as the terminal apparatus 100, the arithmetic unit 1030 of the computer 1000 realizes the functions of the control unit 150 by executing the program loaded on the primary storage device 1040. Furthermore, in a case where the computer 1000 functions as the information offering apparatus 10, the arithmetic unit 1030 of the computer 1000 realizes the functions of the control unit 40 by executing the program loaded on the primary storage device 1040.

### 7. Effects

As described above, the information offering apparatus 10 can perform concealment processing on content by using a privacy-related context. For example, the information offering apparatus 10 can specify a portion of content that satisfies a predetermined condition set in advance. Further, the information offering apparatus 10 can specify a context that satisfies a predetermined condition among contexts included in content. The context that satisfies the predetermined condition can include a privacy-related context including personal information and information about a content disclosing target person. In addition, the information offering apparatus 10 can acquire information on a context from a user's terminal apparatus.

Further, the information offering apparatus 10 can generate converted content by changing a portion of content specified by a specifying unit according to predetermined processing contents set in advance. Further, the information offering apparatus 10 can post the converted content to an SNS server. Further, the information offering apparatus 10 can accept registration of policy information including a combination of a predetermined condition and predetermined processing contents from a user's terminal apparatus. Further, the information offering apparatus 10 can perform changing processing on portions of content that satisfy different predetermined conditions according to different predetermined processing contents.

Although some of the embodiments of the present application have been described in detail with reference to the drawings, these are illustrative examples, and the present invention can be implemented in other forms obtained by making various modifications and improvements including the aspect described in the disclosure of the invention based on knowledge of persons skilled in the art.

Furthermore, “section”, “module”, and “unit” described above can be read as “means” or “circuit”. For example, the acquisition unit can be read as acquisition means or an acquisition circuit.

According to an aspect of the embodiment, content concealment processing using a privacy-related context can be performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquisition unit that acquires content to be disclosed from a user's terminal apparatus; and
a specifying unit that specifies a portion of the acquired content that meets a predetermined condition set in advance.

2. The information processing apparatus according to claim 1, wherein
the specifying unit specifies a context that meets the predetermined condition among contexts included in the content.

3. The information processing apparatus according to claim 2, wherein
the context that meets the predetermined condition is a privacy-related context including personal information.

4. The information processing apparatus according to claim 2, wherein
the context that meets the predetermined condition is a context concerning a person who discloses the content.

5. The information processing apparatus according to claim 2, wherein
the context that meets the predetermined condition is a context concerning a viewer of the content.

6. The information processing apparatus according to claim 1, further comprising:
a generation unit that generates converted content by changing the portion of the content specified by the specifying unit in accordance with predetermined processing contents set in advance; and
an output unit that outputs the converted content.

7. The information processing apparatus according to claim 6, wherein
the output unit posts the converted content to an SNS server.

8. The information processing apparatus according to claim 6, further comprising:
a receiving unit that accepts registration of policy information including a combination of the predetermined condition and the predetermined processing contents; and
a storage unit in which the policy information is stored.

9. The information processing apparatus according to claim 8, wherein
the receiving unit accepts registration of the policy information from the user's terminal apparatus.

10. The information processing apparatus according to claim 8, wherein
the receiving unit accepts registration of the policy information from a viewer of the content.

11. The information processing apparatus according to claim 8, wherein
the receiving unit accepts registration of the policy information from a service provider that offers a service concerning the content.

12. The information processing apparatus according to claim 6, wherein
the generation unit converts the portion of the content specified by the specifying unit into another element.

13. The information processing apparatus according to claim 6, wherein
the generation unit covers the portion of the content specified by the specifying unit with an element that hinders recognition.

14. The information processing apparatus according to claim 6, wherein
the generation unit erases the portion of the content specified by the specifying unit.

15. The information processing apparatus according to claim 6, wherein
the generation unit performs changing processing on portions of the content that meet different predetermined conditions in accordance with different predetermined processing contents.

16. The information processing apparatus according to claim 1, wherein
the content includes at least one of a photo, a document, a moving image, and voice.

17. An information processing method performed by an information processing apparatus, comprising:
acquiring content to be disclosed from a user's terminal apparatus; and
specifying a step portion of the acquired content that meets a predetermined condition set in advance.

18. A non-transitory computer readable storage medium storing a program for causing a computer to execute processes comprising:
acquiring content to be disclosed from a user's terminal apparatus; and
specifying a procedure portion of the acquired content that meets a predetermined condition set in advance.
